(19) United States
(12) Patent Application Publication
(10) Pub. No.: US 2024/0235453 A1
(43) Pub. Date: Jul. 11, 2024

(54) MOTOR AIR GAP AIR INJECTION PUMP CONTROL

(71) Applicant: GM Global Technology Operations LLC, Detroit, MI (US)

(72) Inventors: Chunhao J. Lee, Troy, MI (US); Farzad Samie, Franklin, MI (US); Xiaofeng Yang, Troy, MI (US)

(21) Appl. No.: 18/150,392

(22) Filed: Jan. 5, 2023

(51) Int. Cl. H02P 29/00; B60L 15/20

(52) U.S. Cl. CPC H02P 29/0027; B60L 15/20; B60L 2240/421; B60L 2240/425

(57) ABSTRACT

A system and control method for displacing a fluid out of an air gap of a propulsion motor is based upon at least one electric propulsion motor parameter and may include actuating an air injection pump configured to inject air into the air gap.

### INTRODUCTION

Electric vehicles (EV) include one or more electric propulsion motors. Such motors may be lubricated and cooled with circulating fluids, including fluids circulating through stator and rotor structures. Circulating fluids may undesirably occupy the air gap between the rotor structure and the stator structure causing quantifiable drag upon the motor rotation resulting in efficiency loss and reduced motor output torque.

Air may be injected into the air gap to displace oil trapped therein. However, not all operating regions and conditions of the propulsion motor may exhibit air gap fluid induced drag. Air injection comes at quantifiable costs in terms of energy consumption. Thus, an intelligent approach to air injection control considering propulsion motor operating conditions and air injection costs may be desirable.

### SUMMARY

In one exemplary embodiment, a control method for an electric propulsion motor having a stator, a rotor and an air gap therebetween may include monitoring a plurality of electric propulsion motor parameters during electric propulsion motor operation, and actuating an air injection pump configured to inject air into the air gap sufficient to displace a fluid out of the air gap based upon at least one of the electric propulsion motor parameters.

In addition to one or more of the features described herein, the plurality of electric propulsion motor parameters may include an electric propulsion motor speed, a flow rate of the fluid, and a temperature of the fluid.

In addition to one or more of the features described herein, the at least one of the electric propulsion motor parameters may include a motor speed.

In addition to one or more of the features described herein, the air injection pump may be actuated when the electric propulsion motor speed is below a first speed.

In addition to one or more of the features described herein, the air injection pump may be actuated when the electric propulsion motor speed is above a second speed greater than the first speed.

In addition to one or more of the features described herein, actuating the air injection pump may include engaging a clutch between a rotor shaft and the air injection pump.

In addition to one or more of the features described herein, the clutch may be engaged when a spin loss attributed to the fluid in the air gap exceeds a spin loss attributed to operating the air injection pump.

In addition to one or more of the features described herein, actuating the air injection pump may include driving an electric pump motor of the air injection pump.

In addition to one or more of the features described herein, actuating the air injection pump may include actuating the air injection pump based upon the electric propulsion motor speed, the flow rate of the fluid, and the temperature of the fluid.

In addition to one or more of the features described herein, the fluid circulates through the electric propulsion motor.

In addition to one or more of the features described herein, driving the electric pump motor of the air injection pump may include driving the electric pump motor at a speed as a function of an electric propulsion motor speed, a flow rate of the fluid, and a temperature of the fluid.

In another exemplary embodiment, an electric propulsion motor system may include an electric propulsion motor having a stator, a rotor and an air gap between the stator and the rotor, a fluid circulation system circulating a fluid through the electric propulsion motor, an air injection pump configured to inject air into the air gap sufficient to displace the fluid out of the air gap, and a controller monitoring electric propulsion motor parameters including an electric propulsion motor speed, a flow rate of the fluid, and a temperature of the fluid, and actuating the air injection pump based upon at least one of the electric propulsion motor speed, the flow rate of the fluid, and the temperature of the fluid.

In addition to one or more of the features described herein, the electric propulsion motor system may further include a controllable clutch selectively coupling the air pump to a rotor shaft, wherein actuating the air injection pump comprises engaging the clutch.

In addition to one or more of the features described herein, the clutch may be engaged when a spin loss attributed to the fluid in the air gap exceeds a spin loss attributed to operating the air injection pump.

In addition to one or more of the features described herein, the electric propulsion motor system may further include an electric pump motor of the air injection pump, wherein actuating the air injection pump comprises driving the electric pump motor of the air injection pump.

In addition to one or more of the features described herein, driving the electric pump motor of the air injection pump may include driving the electric pump motor at a speed as a function of the electric propulsion motor speed, the flow rate of the fluid, and the temperature of the fluid.

In yet another exemplary embodiment, a control method for an electric propulsion motor having a stator, a rotor and an air gap therebetween may include circulating a fluid through the electric propulsion motor, monitoring electric propulsion motor parameters including an electric propulsion motor speed, a flow rate of the fluid, and a temperature of the fluid, actuating an air injection pump based upon at least one of the electric propulsion motor speed, the flow rate of the fluid, and the temperature of the fluid, whereby air is injected into the air gap sufficient to displace the fluid out of the air gap.

In addition to one or more of the features described herein, the air injection pump may be actuated when the electric propulsion motor speed is below a first speed.

In addition to one or more of the features described herein, the air injection pump may be actuated when the electric propulsion motor speed is above a second speed greater than the first speed.

In addition to one or more of the features described herein, actuating the air injection pump may include engaging a clutch between a rotor shaft and the air injection pump, wherein the clutch is engaged when a spin loss attributed to the fluid in the air gap exceeds a spin loss attributed to operating the air injection pump.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates a vehicle and propulsion system, in accordance with one or more embodiments;

FIG. 2 illustrates an electric propulsion motor and control, in accordance with one or more embodiments;

FIG. 3 illustrates an electric propulsion motor and control, in accordance with one or more embodiments;

FIG. 4 illustrates characteristic air gap spin losses in an electric propulsion motor, in accordance with one or more embodiments;

FIG. 5 illustrates characteristic air gap spin loss reductions with air injection in an electric propulsion motor, in accordance with one or more embodiments;

FIG. 6 illustrates a control method routine, in accordance with one or more embodiments; and

FIG. 7 illustrates desired air pressures across electric propulsion motor speeds at various fluid leakage rates at a standard temperature, in accordance with one or more embodiments.

### DETAILED DESCRIPTION

The following description is merely exemplary in nature and is not intended to limit the present disclosure, its application or uses. Throughout the drawings, corresponding reference numerals indicate like or corresponding parts and features.

As used herein, electronic control unit (ECU), control module, module, control, controller, control unit, electronic control unit, processor and similar terms may refer to any hardware, software, firmware, electronic control component, processing logic, and/or processor device, individually or in any combination. In various embodiments, a control module may include any one or various combinations of one or more of Application Specific Integrated Circuit(s) (ASIC), electronic circuit(s), central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, and in-plant and service-related networks including for over the air (OTA) software updates. Functions of a control module as set forth in this disclosure may be performed in a distributed control architecture among several networked control modules. Software, firmware, programs, instructions, routines, code, algorithms and similar terms mean any controller executable instruction sets including calibrations, data structures, and look-up tables. A control module may have a set of control routines executed to provide described functions. Routines are executed, such as by a central processing unit, and are operable to monitor inputs from sensing devices and other networked control modules and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests.

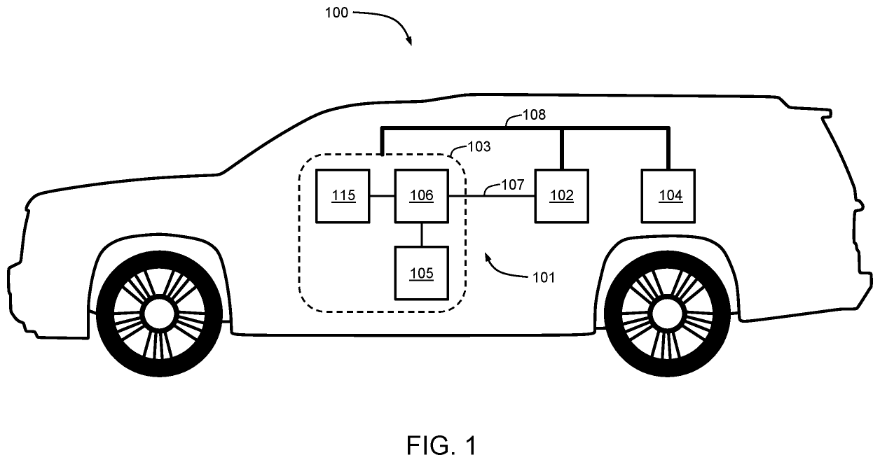

FIG. 1 is a functional block diagram depicting an exemplary mobile platform as a vehicle 100. Vehicle and vehicular are understood to refer to any means of transportation including non-limiting examples of motorcycles, cars, trucks, buses, excavation, earth moving, construction and farming equipment, railed vehicles like trains and trams, aircraft, and watercraft like ships and boats. As is generally understood, the vehicle 100 may embody a body, chassis, and wheels, each of which are rotationally coupled to the chassis near a respective corner of the body. The vehicle 100 may be a four wheel vehicle, but the number of wheels may vary in other embodiments. The vehicle 100 may be autonomous or semi-autonomous. The vehicle 100 may include a vehicle propulsion system 101 including a rechargeable energy storage system (RESS) 102, an electric drive unit (EDU) 103 and an electric control unit (ECU) 104. The EDU 103 may include a transmission 115, a fluid circuit 105, and an electric propulsion motor 106. As used herein, RESS 102 may include a high voltage battery pack primarily for servicing the EDU 103 and one or more low voltage batteries primarily for servicing low voltage vehicle loads. A high voltage (HV) direct current (DC) bus 107 provides electrical power transfer between the EDU 103 and a rechargeable energy storage system 102. In various embodiments, the RESS 102 and the EDU 103 may be operatively coupled to one or more on-vehicle components and systems, including the ECU 104, via a communication bus 108.

The RESS 102 is generally operational to store energy used by the electric propulsion motor 106. In a charging mode, the RESS 102 may receive electrical current from a generator and/or external source. In a discharging mode, the RESS 102 may provide electrical current to the electric propulsion motor 106 and other loads. The RESS 102 may include multiple battery modules electrically connected in series and/or in parallel between a positive battery pack terminal and a negative battery pack terminal. In various embodiments, the RESS 102 may provide approximately 200 to 1,000 volts DC electrical potential between the positive battery pack terminal and the negative battery pack terminal. Other battery voltages may be implemented to meet the design criteria of a particular application. The RESS 102 may be physically and electrically coupled to the HV DC bus 107.

The transmission 115 is generally operational to transfer mechanical torque from the electric propulsion motor 106 to the wheels of the vehicle 100. In various embodiments, the transmission 115 may implement a geared transmission. In other embodiments, the transmission 115 may implement a continuously variable transmission.

The fluid circuit 105 is generally operational to provide a working fluid to the electric propulsion motor 106. The fluid may be used to lubricate and/or cool the electric propulsion motor 106. In various embodiments, the fluid may be circulated within the EDU 103 including through the electric propulsion motor 106. In some embodiments, the fluid circuit 105 may include a sump providing a return reservoir for circulated fluid and a mechanically or electrically driven fluid pump. In any case, fluid flow rate may be known to the ECU 104 directly through flow sensing or indirectly through modeling and calibrations. In some embodiments, the fluid may be an oil and/or a coolant.

The electric propulsion motor 106 may be a drive motor for the vehicle 100. The electric propulsion motor 106 is generally operational to provide rotation and torque to drive wheels of the vehicle 100. The electrical power consumed by the electric propulsion motor 106 may be provided by the RESS 102 via the HV DC bus 107 to a power inverter which converts the DC to multiphase AC. The electric propulsion motor 106 may be a multiphase AC motor including a stator and a rotor. The rotor may be disposed within the stator, and separated from the stator by an air gap. A rotor shaft may be connected to the rotor. The narrow air gap may undesirably accumulate fluid circulated through the electric propulsion motor 106 and, more particularly, through stator and rotor structures. An air injection pump may be configured to inject air into the air gap through the stator and/or the rotor. The air injected into the air gap may force the fluid out of the air gap thereby reducing the drag on the rotor.

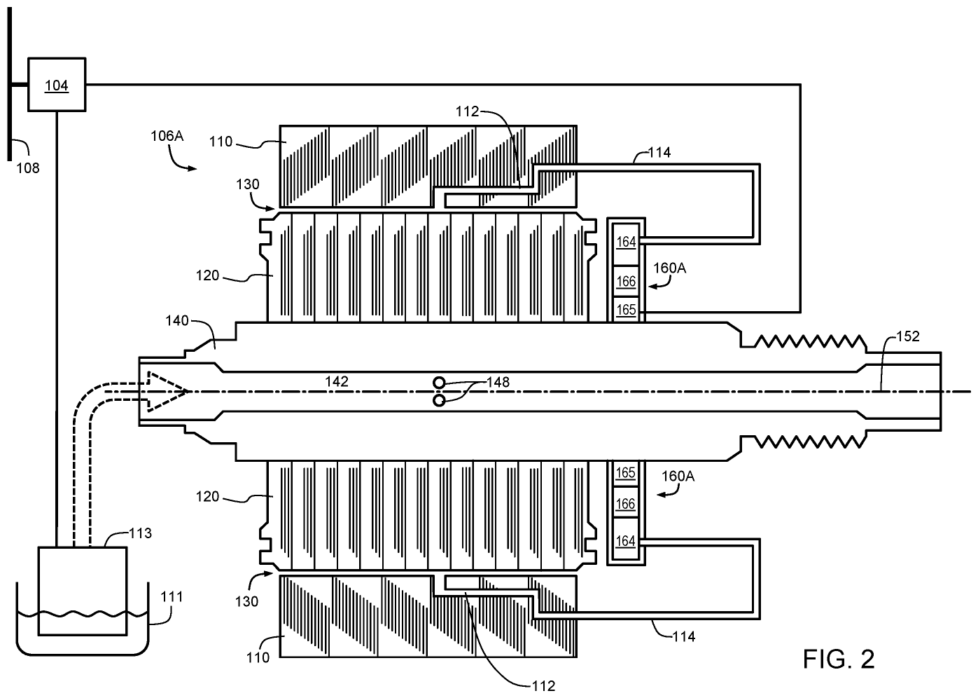

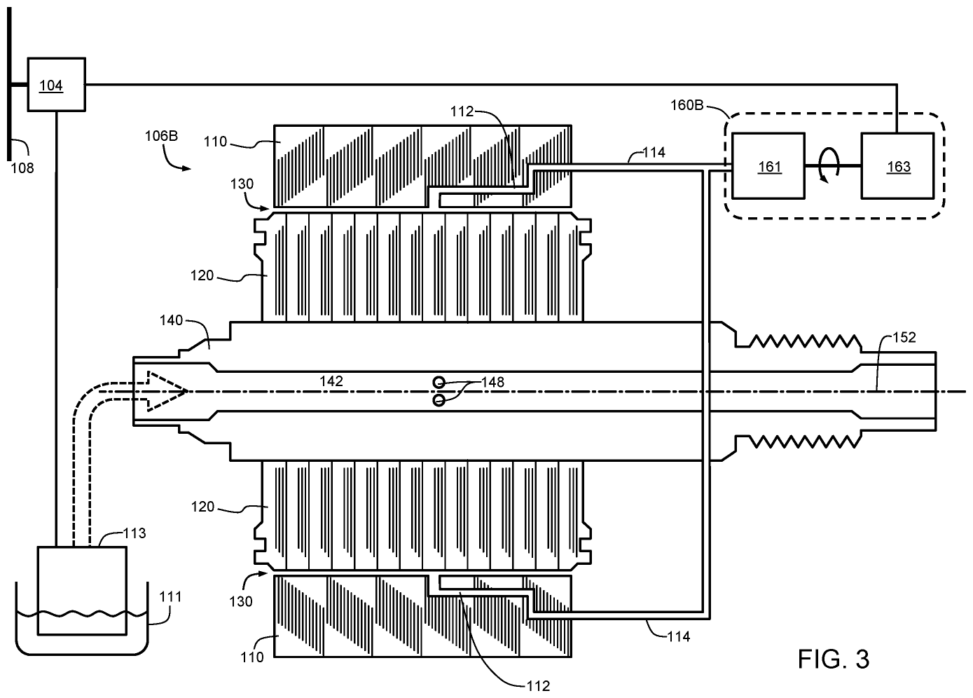

Referring to FIGS. 2 and 3, a schematic cross-sectional diagram of an electric propulsion motor 106A is illustrated in accordance with respective exemplary embodiments. The electric propulsion motor 106A may be one embodiment of the electric propulsion motor 106 as generally described herein with respect to FIG. 1. The electric propulsion motors 106A (FIG. 2) and 106B (FIG. 3) include a stator 110, at least one air injection conduit 114 (multiple shown), a rotor 120, the air gap 130, a rotor shaft 140, and an air injection pump 160A (FIG. 2) or 160B (FIG. 3).

The stator 110 may be one embodiment of the stator as generally described herein with respect to FIG. 1. The stator 110 may include multiple stacked annular laminations of electrical steel forming a cylindrical core with winding slots toward the interior. The stator 110 may include multiphase AC windings within the winding slots which receiving multiphase AC from the power inverter to establish a rotating magnetic field. The stator 110 may include at least one stator air line 112 (multiple shown). The stator air lines 112 are generally operational to receive pressurized air through the air injection conduit 114 from the air injection pump 160A (FIG. 2) or 160B (FIG. 3) and inject it into the air gap 130. The stator air lines 112 may be located approximately midway in the stator 110 along an axis of rotation 152 of the electric propulsion motors 106A (FIG. 2) and 106B (FIG. 3). The stator may include fluid passages (not shown) for directing the flow of pressurized fluid. In an embodiment, fluid may be directed over stator winding end turns and/or through the stator core structure via fluid passages formed in the lamination stack. For example, fluid passages may run axially through the stator core and fluid flow designed to flow from one end of the stator core to the opposite end of the stator core. Once fluid has been directed through the stator, it is generally free to flow back to a sump 111 or other area within the EDU 103 for retrieval and recirculation.

The rotor 120 may be one embodiment of the rotor as generally described herein with respect to FIG. 1. The rotor 120 may include multiple annular stacked laminations forming a core. In a permanent magnet machine, the stacked laminations may include voids forming interior pockets for carrying permanent magnets. In an induction machine, the stacked laminations may include peripheral slots for carrying conduction bars. Alternative rotor constructions are known to those having ordinary skill in the art and may include, for example, surface mounted permanent magnet and wire wound rotors.

The air gap 130 may provide a physical gap between an inside surface of the stator 110 and an outer surface of the rotor 120. The air gap may undesirably accumulate fluid circulated through the electric propulsion motor 106. The air injection pump 160A (FIG. 2) or 160B (FIG. 3) may be configured to inject air into the air gap through the stator 110. The air injected into the air gap 130 may force the fluid out of the air gap thereby reducing the drag on the rotor. Air flowing through the stator 110 and the air gap 130 may cool the stator 110 in addition to displacing fluid in the gap 130. The air flowing through the air gap 130 may also cool the rotor 120. In an embodiment, the air gap 130 between the stator 110 and the rotor 120 may be less than a millimeter (mm). In other embodiments, the air gap 130 may be less than 0.5 mm (e.g., 0.2 mm to 0.45 mm). Other sizes of the air gap 130 may be implemented to meet the design criteria of a particular design.

The rotor shaft 140 may be one embodiment of the rotor shaft as generally described herein with respect to FIG. 1. The rotor shaft 140 is affixed to the rotor 120 and rotates therewith. The rotor shaft 140 may include an axial fluid passage 142 and at least one lubrication hole 148 (multiple shown). The rotor shaft 140 may be rotatably supported at both ends of the rotor 120 by bearings (not illustrated) and may transfer the mechanical torque generated by the rotor 120 to the transmission 115. The rotor shaft 140 spins about an axis of rotation 152. The axial fluid passage 142 receives pressurized fluid from one end of the rotor shaft 140. From the axial fluid passage 142, the fluid may flow into the lubrication holes 148 and through passages in the rotor core. For example, fluid passages run axially adjacent permanent magnets in an interior permanent magnet machine and fluid flow is designed to flow from a central inlet, through the fluid passages and out at opposite ends of the rotor core. Alternatively, fluid may flow from a central inlet, through the fluid passages from one end of the rotor core through to an opposite end of the rotor core and out. As with the fluid flow associated with the stator, once fluid has been directed through the rotor, it is generally free to flow back to a sump or other area within the EDU for retrieval and recirculation.

An electrically driven fluid pump 113 may be one embodiment of the fluid pump as generally described herein with respect to FIG. 1. The electrically driven fluid pump 113 is configured for drawing fluid from a sump 111 and delivering it to the axial fluid passage 142 within the rotor shaft 140 for circulation through the rotor core as described further herein. The electrically driven fluid pump 113 may be signally coupled to the ECU 104 for receiving control commands therefrom and providing information thereto.

With respect to the embodiment of FIG. 2, the air injection pump 160A may be one embodiment of the air injection pump as generally described herein with respect to FIG. 1. The air injection pump 160A may be a fixed displacement pump. The air injection pump 160A may be a mechanically driven air injection pump. The air injection pump 160A is operational to move air through the injection conduit 114 and the stator air lines 112 into the air gap 130. The air injection pump 160A may be located at either end of the rotor shaft 140.

The air injection pump 160A generally comprises a stationary portion 164 and a rotating portion 166. The stationary portion 164 may be physically connected to a frame of the electric propulsion motor 106A (e.g., EDU 103 housing). The rotating portion 166 may be physically connected to the rotor shaft 140. In an embodiment, a controllable clutch 165 may selectively engage the rotor 140 to the air injection pump 160A at the rotating portion 166. The air injection pump 160A is driven by the rotation of the rotor shaft 140 to pump air out of the stationary portion 164. The output of the air injection pump 160A is fixed in accordance with the rotational speed of the rotor shaft and is subject to binary control (i.e., on or off) via the controllable clutch 165. The clutch 165 may be signally coupled to the ECU 104 for receiving control commands therefrom and providing information thereto.

With respect to the embodiment of FIG. 3, the air injection pump 160B may be one embodiment of the air injection pump as generally described herein with respect to FIG. 1. The air injection pump 160B may include a pump section 161 operatively coupled to an electric pump motor 163. The electric pump motor 163 may be powered by a low voltage battery of the RESS 102.

The air injection pump 160B is operational to move air through the injection conduit 114 and the stator air lines 112 into the air gap 130. The air injection pump 160B may be located within, on or otherwise apart from the EDU 103. In an embodiment, the air injection pump 160B may be a variable displacement pump effective via speed control of the electric pump motor 163. Thus, the output of the air injection pump 160B is variable in accordance with the rotational speed of the electric pump motor 163.

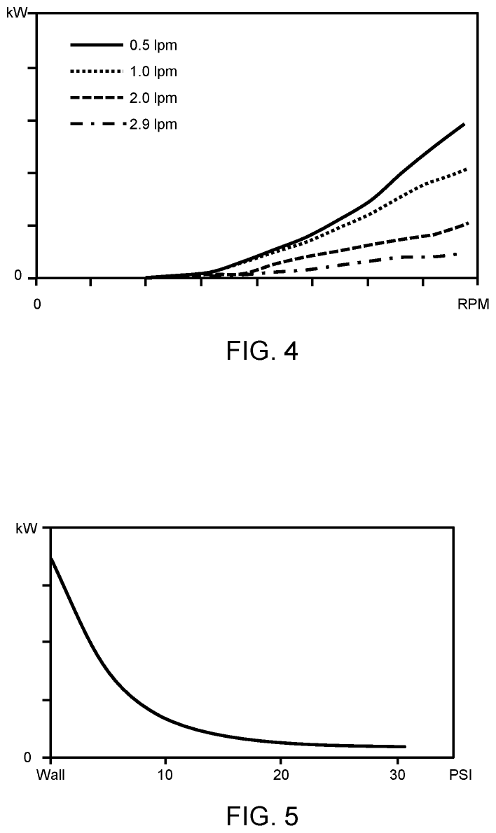

Bench testing of an exemplary electric propulsion motor as described has shown the general trend of increasing spin losses of the electric propulsion motor at higher rotational speeds and larger fluid flows. FIG. 4 exemplifies this general relationship and corresponds to fluid at an exemplary temperature of about 50 degrees Celsius. The horizontal axis represents relative rotor rotational speed (revolutions per minute (RPM)) and the vertical axis represents relative air gap spin loss (kilowatts (kW)). The four plotted curves represent exemplary data corresponding to different flow rates of fluid through the rotor and/or stator cores which also corresponds to the flow rate from the fluid pump 160 from 0.5 liters per minute (lpm) through 2.9 lpm. It is appreciated that spin losses generally increase with higher fluid flow rates at any given rotor speed and generally increase with increasing rotor speed at any given fluid flow rate.

Simulations of gap accumulation of fluid has demonstrated that at low speeds of operation (e.g., below about 1500 RPM in an embodiment), fluid may accumulate in the air gap causing relatively high spin losses. Simulations of gap accumulation of fluid has demonstrated that at some point in regions of low speed operation (e.g., between about 1000 RPM and 2000 RPM in an embodiment), fluid in the air gap may be pushed away from the rotor outer diameter resulting in relatively low spin losses. Simulations of gap accumulation of fluid has demonstrated that at operating speeds above an intermediate speed of operation (e.g., about 5000 RPM in an embodiment), fluid in the air gap may be stuck on the rotor outer diameter resulting in relatively high spin losses.

Additional simulations have demonstrated a general trend in air gap spin loss versus delivered air pressure through centrally disposed stator air lines 112 as described herein. FIG. 5 illustrates, for an exemplary set of conditions including a motor speed close to machine limits, room temperature fluid, and relatively low fluid leak rate into the air gap, sustained injected air pressure (PSI) along the horizontal axis and relative air gap spin losses (kW) along the vertical axis. It is appreciated that the fluid leak rate into the air gap may have a known relationship or correspondence to the overall fluid flow rate from the fluid pump 160. The shape of the plotted data curves generally supports rapid early gains of efficiency with a unit of air injection pressure followed by an inflection point, whereafter rapidly decreasing gains of efficiency are experienced for each unit of air injection pressure.

Thus, it is appreciated that an air gap free of fluid is desirable and corresponds to lower spin losses of the rotor. Further, it is appreciated that the fluid accumulation within the air gap 130 may be a function of rotor speed, fluid temperature (viscosity) and fluid flow rate.

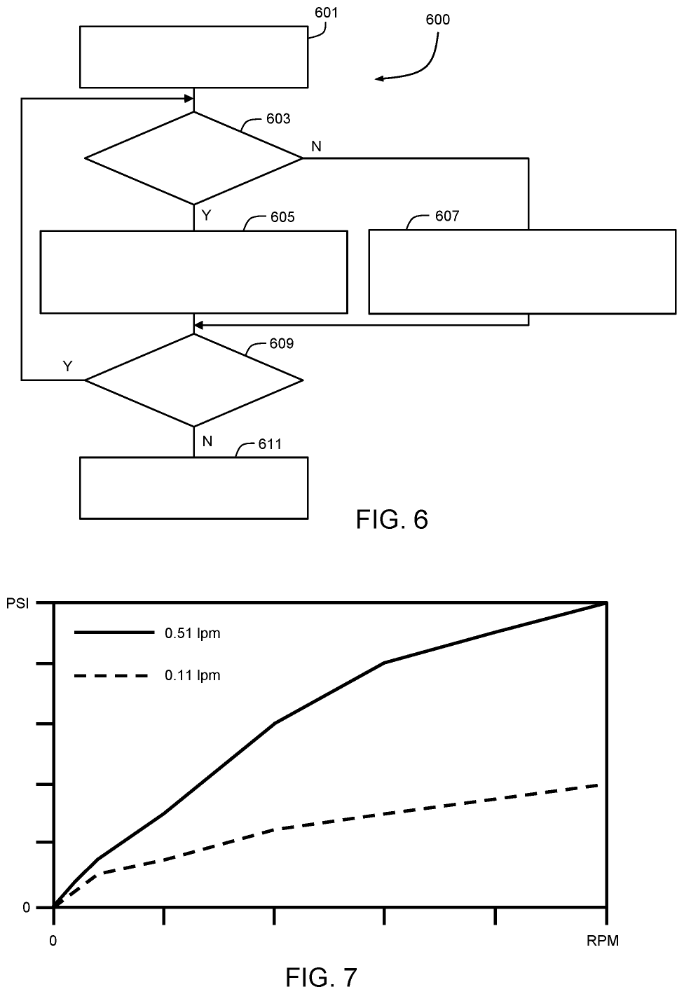

In accordance with an embodiment, a method for controlling an air injection pump as set forth herein for displacement of fluid from within the air gap of an operating electric propulsion motor is illustrated in routine 600 in FIG. 6. The routine 600 may initiate during a propulsion mode of operation 601 for example during an active drive cycle. During a propulsion mode of operation, entry conditions at 603 determine whether the method detects conditions suitable for active air injection control at 605 or conditions unsuitable for active air injection control at 607. In an embodiment, the routine 600 may consider the fluid temperature, the fluid flow rate and the electric propulsion motor speed. In an embodiment, zero motor speed at 603 may indicate that no air injection is required and thus move to 607. Similarly, no fluid flow may indicate that no air injection is required and thus move to 607. At 607, the air injection pump may be commanded off by the ECU 104. In the case of a clutch controlled air injection pump 160A (FIG. 2), the clutch 165 may be commanded off. In the case of an electric pump motor 163 driven air injection pump 160B, the electric pump motor 163 may be commanded off. In either embodiment, no air injection is requested. In an embodiment, non-zero electric propulsion motor speed at 603 may indicate that air injection may be required. In an embodiment, speed regions may dictate whether air injection may be required. For example, at low, non-zero speeds below a first predetermined threshold speed (e.g., 1500 RPM), air injection may be desirable. Similarly, at speeds above a second predetermined threshold speed (e.g., 5000 RPM), air injection may also be desirable. However, in the speed region between the first and second predetermined threshold speeds, air injection may be undesirable. Thus, when the electric propulsion motor speed is between the two exemplary predetermined threshold speeds (e.g., 1500 RPM and 5000 RPM), the conditions for air injection may be unsuitable and the air injection pump may be commanded off at 607 by the ECU 104. However, when the electric propulsion motor speed is not between the two exemplary predetermined threshold speeds (e.g., 1500 RPM and 5000 RPM), the conditions for air injection may be suitable and the air injection pump may be commanded on at 605 by the ECU 104.

At 605, in the case of a clutch controlled air injection pump 160A (FIG. 2), the clutch 165 may be commanded on such that the rotor shaft 140 is engaged with the air injection pump 160A. In an embodiment, the clutch 165 may be commanded on based upon costing decisions (e.g., comparison of drag (i.e., spin) losses due to air gap fluid and power consumed by the air injection pump) such that commanding the clutch 165 on and running the air injection pump 160A results in a net efficiency gain. Thus, for example, the clutch 165 may be engaged when spin losses due to accumulated fluid in the air gap exceed the spin losses due to an operating air injection pump. Spin losses for an operating air injection pump may be empirically determined and saved in table format and referenced by motor speed, for example. Spin losses due to accumulated fluid in the air gap may similarly be determined and saved in table format and referenced by electric propulsion motor speed, fluid flow rate and fluid temperature, for example. Alternatively, spin losses due to accumulated fluid in the air gap may be approximated real-time by a power balancing model or similar technique, for example. In the case of an electric pump motor 163 driven air injection pump 160B, the electric pump motor 163 may be commanded on and to a requested speed. In either embodiment, air injection is requested at 605.

In an embodiment, at 605, in the case of an electric pump motor 163 driven air injection pump 160B, a desired air pressure for the electric pump motor 163 may be determined. Advantageously, desired air pressure for the air injection pump 160B may be empirically determined and stored in multidimensional calibration look-up tables. For example, a three dimensional data set may be created and referenced with the electric propulsion motor speed, the fluid flow rate and the fluid temperature to return a desired air pressure. Generally, the air pressure will correspond to some spin loss objective and advantageously may take into consideration minimizing overall spin losses and electric pump motor 163 energy consumption in a cost minimization.

In an alternate embodiment in the case of an electric pump motor 163 driven air injection pump 160B, the desired air pressure may be plotted against electric propulsion motor speed at a standard temperature (e.g., 26 degrees Celsius) for various fluid leakage rates which correlate to fluid flow rates which may readily be determined in application. Such a plot may be seen at FIG. 7 wherein relative electric propulsion motor speed (RPM) is along the horizontal axis and relative air injection pump pressure (PSI) is along the vertical axis. For given fluid leakage rates (e.g., 0.11 lpm and 0.51 lpm), a desired air injection pump pressure may be plotted. As before, the desired air injection pump pressure may correspond to some spin loss objective and advantageously may take into consideration minimizing overall spin losses and electric pump motor 163 energy consumption in a cost minimization. Such consolidated dataset may provide the basis for determining a baseline desired air injection pump pressure based upon the known electric propulsion motor speed and fluid flow. The baseline desired air injection pump pressure may then be corrected for temperature, for example in accordance with the following temperature correction relationship:

$$P = {P}_{0} [ 1 - C ( T - {T}_{0} ) ] \qquad [ 1 ]$$

wherein P is the desired air injection pump pressure;
C is a temperature coefficient;
T is the fluid temperature;
T₀ is the standard temperature for the fluid (e.g., 26 degrees Celsius); and
P₀ is the baseline desired air injection pump pressure.
   The electric pump motor 163 speed may then be controlled to achieve the desired air pressure or additional calibration correlation between desired air injection pump pressure and electric propulsion motor speed may be performed and referenced.

In an alternate embodiment in the case of an electric pump motor 163 driven air injection pump 160B, the desired air pressure corresponding to operating points in the operating space defined by the fluid temperature, the fluid flow rate and the electric propulsion motor speed may be defined by one or more multivariable (i.e., fluid temperature, fluid flow rate and electric propulsion motor speed) equations.

In each of 605 and 607, a drag torque may be determined from the reported electric propulsion motor torque (e.g., bus data) and reported electric propulsion motor current (also bus data). The difference between the reported torque and the torque calculated from the reported current may represent the drag torque. The drag torque may be used as a parameter in a rationality check for diagnosing the air injection pump performance, in an adaptive control scheme to fine tune or dial in the air injection pump pressure for drag reduction, and in cost decisions considered in controlling clutch 165 as set forth further herein.

At 609, when the propulsion mode continues active then the routine returns to 603 for ongoing execution of the routine 600. When the propulsion mode has ended, the air injection pump may be commanded off at 611 and the routine 600 ends.

The terminology used herein is for the purpose of describing particular embodiments only and is not intended to be limiting. The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

All numeric values herein are assumed to be modified by the term “about” whether or not explicitly indicated. For the purposes of the present disclosure, ranges may be expressed as from “about” one particular value to “about” another particular value. The term “about” generally refers to a range of numeric values that one of skill in the art would consider equivalent to the recited numeric value, having the same function or result, or reasonably within manufacturing tolerances of the recited numeric value generally. Similarly, numeric values set forth herein are by way of non-limiting example and may be nominal values, it being understood that actual values may vary from nominal values in accordance with environment, design and manufacturing tolerance, age and other factors.

When an element such as a layer, film, region, or substrate is referred to as being “on” another element, it can be directly on the other element or intervening elements may also be present. In contrast, when an element is referred to as being “directly on” another element, there are no intervening elements present. Therefore, unless explicitly described as being “direct,” when a relationship between first and second elements is described in the above disclosure, that relationship may be a direct relationship where no other intervening elements are present between the first and second elements but may also be an indirect relationship where one or more intervening elements are present (either spatially or functionally) between the first and second elements.

One or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Unless defined otherwise, technical and scientific terms used herein have the same meaning as is commonly understood by one of skill in the art to which this disclosure belongs.

Unless specified to the contrary herein, all test standards are the most recent standard in effect as of the filing date of this application, or, if priority is claimed, the filing date of the earliest priority application in which the test standard appears.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A control method for an electric propulsion motor having a stator, a rotor and an air gap therebetween, comprising:
monitoring a plurality of electric propulsion motor parameters during electric propulsion motor operation; and
actuating an air injection pump configured to inject air at a desired air pressure into the air gap sufficient to displace a fluid out of the air gap based upon at least one of the electric propulsion motor parameters,
wherein the desired air pressure is determined at least in part based on a temperature of the fluid.

2. The control method for the electric propulsion motor of claim 1, wherein the plurality of electric propulsion motor parameters comprises an electric propulsion motor speed, a flow rate of the fluid, and a temperature of the fluid.

3. The control method for the electric propulsion motor of claim 1, wherein the at least one of the electric propulsion motor parameters comprises a motor speed.

4. The control method for the electric propulsion motor of claim 3, wherein the air injection pump is actuated when the electric propulsion motor speed is below a first speed.

5. The control method for the electric propulsion motor of claim 4, wherein the air injection pump is actuated when the electric propulsion motor speed is above a second speed greater than the first speed.

6. The control method for the electric motor of claim 1, wherein actuating the air injection pump comprises engaging a clutch between a rotor shaft and the air injection pump.

7. The control method for the electric motor of claim 6, wherein the clutch is engaged when a spin loss attributed to the fluid in the air gap exceeds a spin loss attributed to operating the air injection pump.

8. The control method for the electric propulsion motor of claim 1, wherein actuating the air injection pump comprises driving an electric pump motor of the air injection pump.

9. The control method for the electric propulsion motor of claim 2, wherein actuating the air injection pump comprises actuating the air injection pump based upon the electric propulsion motor speed, the flow rate of the fluid, and the temperature of the fluid.

10. The control method for the electric propulsion motor of claim 1, wherein the fluid circulates through the electric propulsion motor.

11. The control method for the electric propulsion motor of claim 8, wherein driving the electric pump motor of the air injection pump comprises driving the electric pump motor at a speed as a function of an electric propulsion motor speed, a flow rate of the fluid, and a temperature of the fluid.

12. An electric propulsion motor system, comprising:
an electric propulsion motor including a stator, a rotor and an air gap between the stator and the rotor;
a fluid circulation system circulating a fluid through the electric propulsion motor;
an air injection pump configured to inject air at a desired air pressure into the air gap sufficient to displace the fluid out of the air gap; and
a controller:
monitoring electric propulsion motor parameters including an electric propulsion motor speed, a flow rate of the fluid, and a temperature of the fluid; and
actuating the air injection pump based upon at least one of the electric propulsion motor speed, the flow rate of the fluid, and the temperature of the fluid,
wherein the desired air pressure is determined at least in part based on a temperature of the fluid.

13. The electric propulsion motor system of claim 12, further comprising a controllable clutch selectively coupling the air pump to a rotor shaft, wherein actuating the air injection pump comprises engaging the controllable clutch.

14. The electric propulsion motor system of claim 13, wherein the controllable clutch is engaged when a spin loss attributed to the fluid in the air gap exceeds a spin loss attributed to operating the air injection pump.

15. The electric propulsion motor system of claim 12, further comprising an electric pump motor of the air injection pump, wherein actuating the air injection pump comprises driving the electric pump motor of the air injection pump.

16. The electric propulsion motor system of claim 15, wherein driving the electric pump motor of the air injection pump comprises driving the electric pump motor at a speed as a function of the electric propulsion motor speed, the flow rate of the fluid, and the temperature of the fluid.

17. A control method for an electric propulsion motor having a stator, a rotor and an air gap therebetween, comprising:
circulating a fluid through the electric propulsion motor;
monitoring electric propulsion motor parameters including an electric propulsion motor speed, a flow rate of the fluid, and a temperature of the fluid; and
actuating an air injection pump based upon at least one of the electric propulsion motor speed, the flow rate of the fluid, and the temperature of the fluid, whereby air is injected at a desired air pressure into the air gap sufficient to displace the fluid out of the air gap,
wherein the desired air pressure is determined at least in part based on the temperature of the fluid.

18. The control method for the electric propulsion motor of claim 17, wherein the air injection pump is actuated when the electric propulsion motor speed is below a first speed.

19. The control method for the electric propulsion motor of claim 18, wherein the air injection pump is actuated when the electric propulsion motor speed is above a second speed greater than the first speed.

20. The control method for an electric motor of claim 17, wherein actuating the air injection pump comprises engaging a clutch between a rotor shaft and the air injection pump, wherein the clutch is engaged when a spin loss attributed to the fluid in the air gap exceeds a spin loss attributed to operating the air injection pump.
